(19) United States
(12) Patent Application Publication
(10) Pub. No.: US 2003/0155728 A1
(43) Pub. Date: Aug. 21, 2003

(54) Attachable package movement apparatus

(76) Inventor: John Dacosta, Seven Mile Beach (KY)

Correspondence Address: Robert J. Van Der Wall, P.A., Suite 1620, Colonial Bank Centre, 1200 Brickell Avenue, Miami, FL, 33131, US

(21) Appl. No.: 10/077,113

(22) Filed: Feb. 19, 2002

(51) Int. Cl. B62B 1/00

(52) U.S. Cl. 280/47.32

(57) ABSTRACT

A movement apparatus for a package having a package outer surface, the apparatus including a roller assembly having an axle mounted roller axle and a roller axle attachment structure for attaching the roller to the package so that the roller extends below the package; and a handle assembly having a handle and a handle attachment structure for attaching the handle to the package so that the handle extends outwardly from the package for gripping by a user to pull the package over a support surface as the package rides on the roller.

### BACKGROUND OF THE INVENTION

1. Field of the Invention

The present invention relates generally to the field of package transport. More specifically the present invention relates to a package movement apparatus that is attachable to the package. It includes an attachable roller assembly and an attachable handle assembly which are fastened to and thereby transform an ordinary existing package into a roller equipped vehicle with a handle. As a result, a person can grip a handle and pull the package over a support surface such as a building floor or a sidewalk as the package rides on a roller, with minimal effort. The package may be of widely varying sizes and shapes.

The package typically has a package bottom surface and package side surfaces separated by package lower edges. The attachable roller assembly preferably includes a roller mounting sheet having a roller mounting sheet contact side. The roller mounting sheet contact side coated with an adhesive, preferably pressure sensitive adhesive. The roller mounting sheet is folded to define a substantially planar roller mounting sheet bottom and a substantially planar roller mounting sheet side so that the roller mounting sheet contact side fits snugly around a package lower edge, with the roller mounting sheet bottom resting against and adhesively bonding to the package bottom surface and the roller mounting sheet side resting against and adhesively bonding to a package side surface.

The invention further includes a laterally spaced apart and substantially parallel pair of axle mounting flanges secured to and extending outwardly from the roller mounting sheet outward side, a roller axle secured to and extending between the axle mounting flanges, and a roller having a central roller axial passageway, the axle fitting through the roller axial passageway so that the roller is rotatably mounted around the axle. The roller mounting sheet bottom alternatively is sized to include lateral wrapping portions extending beyond opposing package lower corners to wrap upwardly around and against opposing package side surfaces for added mounting strength. In this embodiment, the roller mounting sheet must match the edge dimension of the package. Preferably, the lateral wrapping portions are omitted so that the length of the roller need not be matched to the edge dimension of the package. Placement of the roller at a package lower edge permits the package to be tilted up at the opposing package end while the package is being pulled. A roller assembly may be mounted at each of two opposing package lower corners so that an end of the package does not have to be lifted while it is being pulled.

The attachable handle assembly preferably includes a handle mounting sheet having a handle mounting sheet contact side coated with an adhesive, preferably pressure sensitive adhesive, for affixing to a package surface near the package upper end and having a handle mounting sheet outward side. A handle is connected to the handle mounting sheet and preferably is a generally U-shaped cutout of the handle mounting sheet with spaced apart handle legs having leg first ends interconnected by a handle connecting segment and having leg second ends connected to the remainder of the handle mounting sheet. Preferably, there is no adhesive on the handle contact side. The handle remains flush with the handle mounting sheet after sheet adhesion to a package surface until the handle is pulled outwardly from the handle mounting sheet, the handle pivoting relative to the remainder of the handle mounting sheet at the leg second ends.

2. Description of the Prior Art

Packages of various sizes and shapes have been developed for containing and protecting all sorts of items to be transported, some of these packages being manufactured in advance to specific dimensions for specific product items and others being custom formed around a single item for individual shipping of the item. A problem with both types of packages has been that they are often too heavy or too cumbersome for safe and convenient movement by a single person.

It is thus an object of the present invention to provide a package movement apparatus which transforms an ordinary existing package into a roller equipped vehicle having a handle for a person to grip and pull the package over a support surface as the package rides on a roller, with minimal effort.

It is another object of the present invention to provide such a package movement apparatus which includes an attachable roller assembly and an attachable handle assembly.

It is still another object of the present invention to provide such a package movement apparatus which can be installed quickly and easily without any special skill and without tools.

It is finally an object of the present invention to provide such a package movement apparatus which is very inexpensive to manufacture, compact, sturdy, reliable and readily disposable because of it low cost.

### SUMMARY OF THE INVENTION

The present invention accomplishes the above-stated objectives, as well as others, as may be determined by a fair reading and interpretation of the entire specification.

A movement apparatus is provided for a package having a package outer surface, the apparatus including a roller assembly and a handle assembly. The roller assembly preferably has an axle mounted roller rotatably mounted on the roller assembly, and attachment structure for connecting the roller axle to the package so that the roller extends below the package. Also included is a handle assembly having a handle and a handle attachment structure. The handle attachment structure serves to connect the handle to the package so that the handle extends outwardly from the package for gripping by a user to pull the package over a support surface as the package rides on the roller.

The package outer surface typically includes a package bottom surface and package side surfaces separated from the package bottom surface by package lower edges. A roller assembly is provided preferably including a roller mounting sheet having a roller mounting sheet contact side coated with an adhesive. The roller mounting sheet is preferably folded to define a roller mounting sheet bottom and a roller mounting sheet side so that the roller mounting sheet contact side fits snugly around a package lower edge, with the roller mounting sheet bottom resting against and adhesively bonding to the package bottom surface and the roller mounting sheet side resting against and adhesively bonding to a package side surface.

The roller assembly includes laterally spaced apart and substantially parallel pair of axle mounting flanges secured to and extending outwardly from the roller mounting sheet outward side.

The roller assembly preferably has an axle mounted roller rotatably mounted on the roller assembly so that the roller extends below the package. The length of the roller need not be matched to the edge dimension of the package. Alternatively, the roller mounting sheet bottom may be wide enough to include lateral wrapping portion so that the roller mounting sheet contact side fits around a package lower corner, with the roller mounting sheet bottom resting against and adhesively bonding to the package bottom surface and the roller mounting sheet lateral wrapping portion resting against and adhesively bonding to a package side surface. In this alternative embodiment, the roller mounting sheet must match the edge dimension of the package.

The handle assembly preferably includes a handle mounting sheet having a handle mounting sheet contact side coated with an adhesive and a handle mounting sheet outward side so that the handle mounting sheet contact side fits against and adhesively bonds to the package outer surface; and a handle connected to the handle mounting sheet. The handle preferably is substantially U-shaped and has two spaced apart handle legs with leg first ends interconnected by a connecting segment and with leg second ends pivotally connected to the handle mounting sheet. The handle optionally is a cut-out of the handle mounting sheet having no adhesive on its contact side, so that the handle remains substantially flush with the handle mounting sheet after adhesion of the handle mounting sheet to a package surface until pulled outwardly from the handle mounting sheet by a user.

The handle mounting sheet alternatively includes two spaced apart slide holes, and the handle alternatively includes a wire bent into a general U-shape with spaced apart handle legs having leg first ends interconnected by a connecting segment and having leg second ends, the handle legs fitting slidably through corresponding the slide holes, the leg second ends having leg lateral bends; so that a user slides the handle legs out of the slide holes until the leg lateral bends abut the handle mounting sheet contact side adjacent to the slide holes and transfer gripping and pulling loading on the handle to the handle mounting sheet and to the package. The adhesive used on the roller mounting sheet contact side and on the handle mounting sheet contact side preferably is a pressure sensitive adhesive.

A movement apparatus is further provided, including a package having a package outer surface; a roller assembly having an axle mounted roller, and including a roller attachment structure for attaching the roller to the package so that the roller extends below the package; and a handle assembly having a handle and a handle attachment structure for attaching the handle to the package so that the handle extends outwardly from the package for gripping by a user to pull the package over a support surface as the package rides on the roller.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a package and of an apparatus handle assembly and roller assembly positioned for attachment to the package.

FIGS. 2 and 3 are opposing perspective views of the package of FIG. 1 with the apparatus handle assembly and roller assembly attached to the package.

FIG. 4 is a perspective view of the package of FIG. 3 with a second roller assembly attached, so that the package can be rolled without lifting the handle end of the package.

FIG. 5 is an exploded view of the elements of a roller assembly.

FIG. 6 is a perspective view of a roller assembly in which the roller mounting sheet remains flat for attachment entirely to a package bottom surface, such as between roller assemblies at opposing package lower corners.

FIG. 7 is a perspective view of a handle assembly having the cut-out handle.

FIG. 8 is a perspective view of a handle assembly having the bent wire handle.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

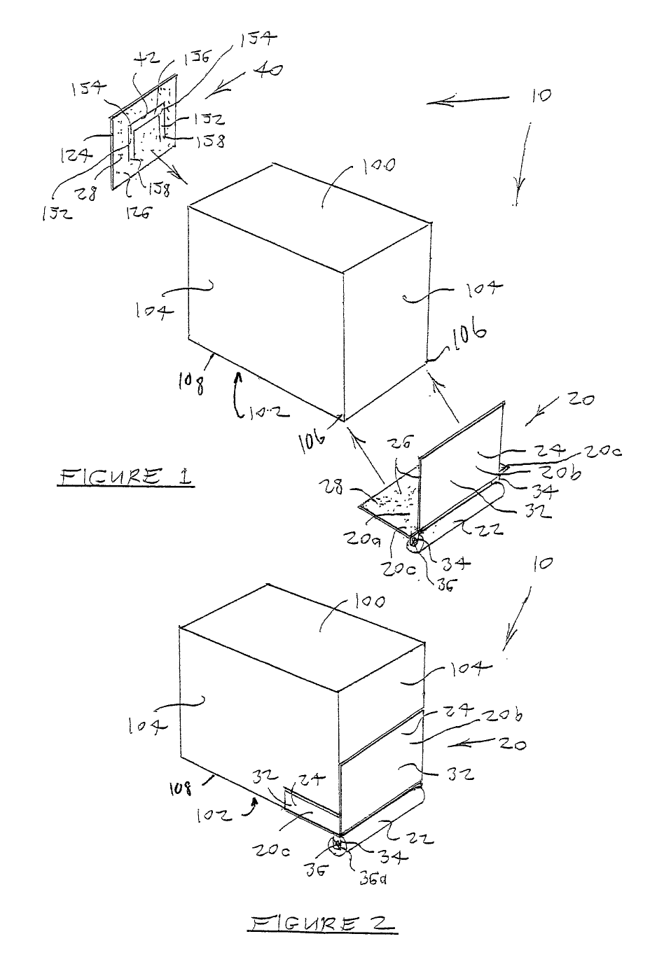

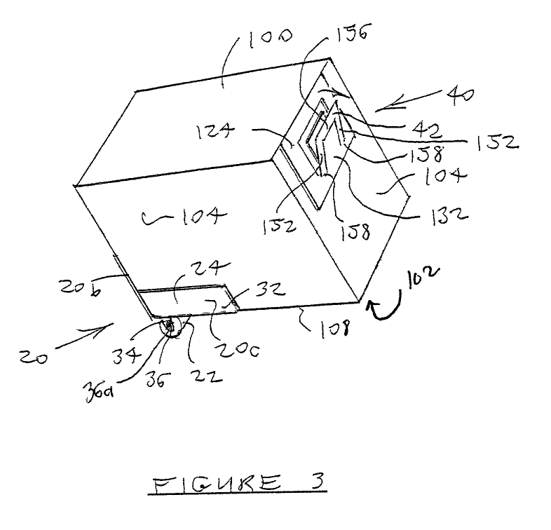

Referring to FIGS. 1-8, a package movement apparatus 10 is disclosed, including an attachable roller assembly 20 and an attachable handle assembly 40 which are fastened to and thereby transform an ordinary existing package 100 into a roller equipped vehicle with a handle 42. As a result, a person can grip the handle 42 and pull the package 100 over a support surface such as a building floor or a sidewalk as the package rides on a roller 22, with minimal effort.

The package 100, has a package bottom surface 102 and package side surfaces 104 separated from the package bottom surface 102 by package lower edges 108, which terminate in package lower corners 106. The attachable roller assembly 20 preferably includes a roller mounting sheet 24 having a roller mounting sheet contact side 26 coated with a pressure sensitive adhesive 28 and a roller mounting sheet outward side 32 and is folded to define a roller mounting sheet bottom 20a and a roller mounting sheet side 20b so that the roller mounting sheet contact side 26 fits snugly around a package, with the roller mounting sheet bottom 20a resting against and adhesively bonding to the package bottom surface 102 and the roller mounting sheet side 20b resting against and adhesively bonding to a package side surface 104, a laterally spaced apart and substantially parallel pair of axle mounting flanges 34 secured to and extending outwardly from the roller mounting sheet outward side 32, supporting an axle mounted roller 22. The axle mounted roller 22 may be comprised of a roller axle 36 secured to and extending between the axle mounting flanges 34, and a roller 22 having a central roller axial passageway 22a, the axle 36 fitting through the roller axial passageway 22a so that the roller 22 is rotatably mounted around the axle 36. See FIG. 5.

Roller securing pins 36a fit removably through diametric holes in axle 36 ends. Release paper 38 preferably covers adhesive 28. The roller mounting sheet bottom 20a alternatively is sized to include two opposing lateral wrapping portions 20c extending beyond opposing package lower corners 106 to wrap upwardly around and against opposing package side surfaces 104 for added mounting strength. But preferably, the lateral wrapping portions 20c are omitted so that the length of the roller 22 need not be matched to the relevant dimension of the package.

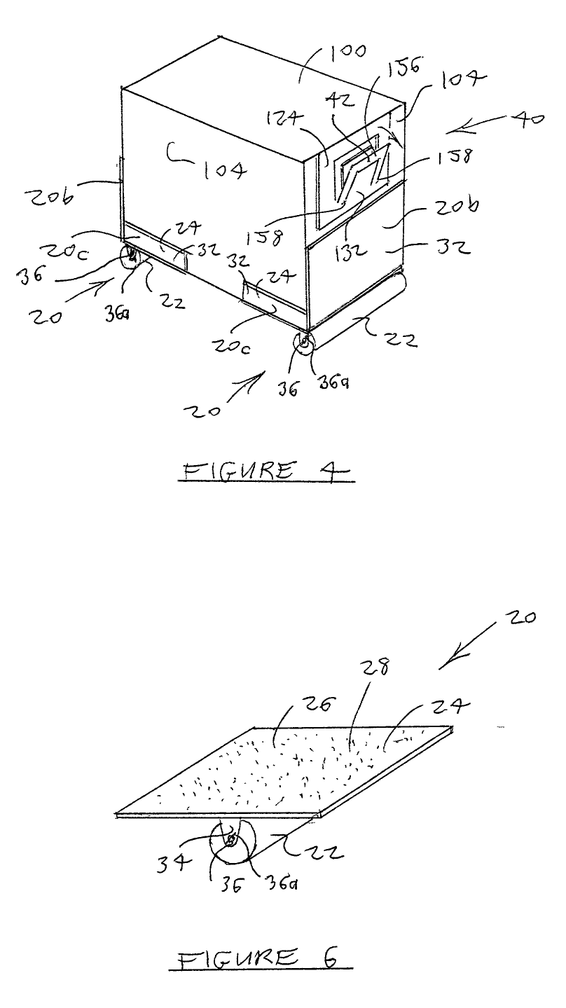

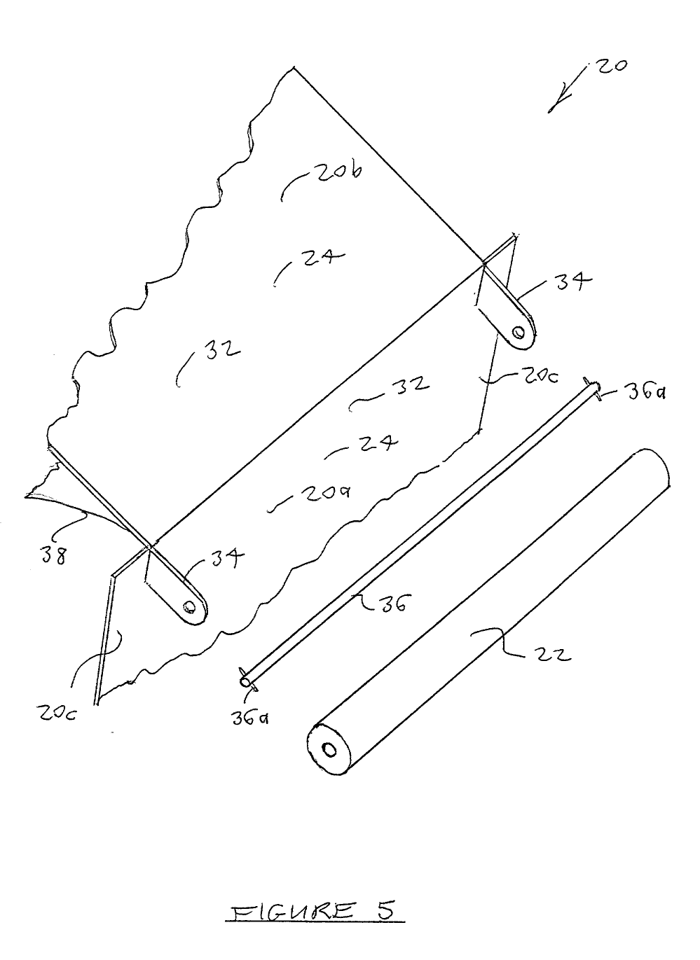

Placement of the roller 22 at a package lower edge 108 permits the package 100 to be tilted up at the opposing package 100 end while the package 100 is being pulled. A roller assembly 20 may be mounted at each of two opposing package lower edges 108. See FIG. 4. Where the package 100 has no well-defined lower corner or to add a roller 22 between package lower corners 108, it is alternatively contemplated that the roller mounting sheet 24 remain substantially planar and the entire roller mounting sheet contact side 26 be placed against the package bottom surface 102, so that the axle mounting flanges 34 protrude downwardly from the package 100. See FIG. 6.

The roller 22 preferably is an elongate cylinder, so that a single roller 22 provides a long and stabilizing line of contact with a package 100 support surface. When using the alternative embodiment, an assortment of roller assemblies 20 having rollers 22 of several lengths may be provided so that the assembly with the appropriate roller 22 length for a given package 100 may be selected. The roller assembly 20 may extend along either a short or long dimension of a package 100, and need not match any lower dimension of the package 100 if the lateral wrapping portions 20c are omitted as described in the preferred embodiment above.

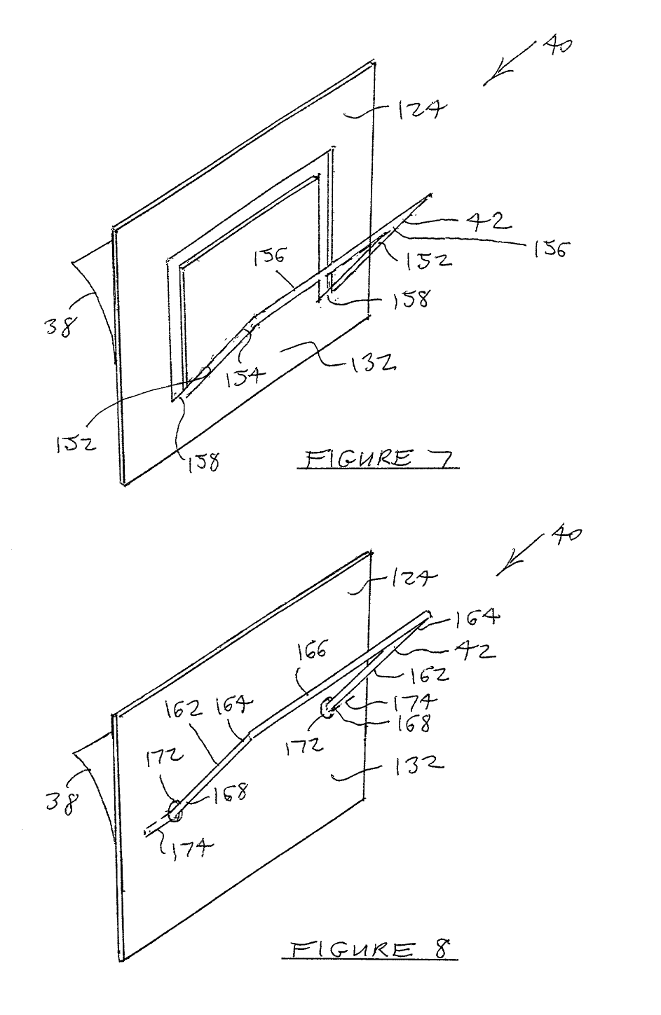

The attachable handle assembly 40 preferably includes a handle mounting sheet 124 having a handle mounting sheet contact side 126 coated with a pressure sensitive adhesive 28 for affixing to a package surface and having a handle mounting sheet outward side 132. See FIGS. 7 and 8. Once again, release paper 38 preferably covers adhesive 28. A handle 42 is connected to the handle mounting sheet 124 and preferably is a generally U-shaped cut-out of the handle mounting sheet 124 with laterally spaced apart handle legs 152 having leg first ends 154 interconnected by a handle connecting segment 156 and having leg second ends 158 connected to the remainder of the handle mounting sheet 124, and with no adhesive 28 on its contact side 126. The handle 42 remains flush with the handle mounting sheet 124 after sheet adhesion to a package 100 surface until the handle 42 is pulled outwardly from the handle mounting sheet 124, the handle 42 pivoting relative to the remainder of handle mounting sheet 124 at the leg second ends 158. See FIG. 7. Alternatively the handle 42 is a wire bent into a general U-shape once again having spaced apart handle legs 162 with leg first ends 164 interconnected by a handle connecting segment 166 and with leg second ends 168 engaging handle mounting sheet 124. See FIG. 8. These handle legs 162 fit slidably through slide holes 172 in handle mounting sheet 124, and the leg second ends 168 have perpendicular bends 174 which function as handle 42 stops, so that when the handle 42 is to be used, the handle legs 162 slide outwardly from respective slide holes 172 in the handle mounting sheet 124 until the perpendicular bends 174 abut the handle mounting sheet contact side 126 adjacent to slide holes 172 at full handle 42 extension and transfer gripping and pulling forces on handle 42 to the handle mounting sheet 124 and thus to the attached package 100.

Where the apparatus 10 is for attachment to a re-usable package 100, the adhesive on the handle mounting sheet contact side 126 is selected during manufacture to be removable and non-damaging to package 100 surfaces.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A movement apparatus for a package comprising:
a roller assembly having an axle mounted roller disposed below the package;
a handle assembly having a handle disposed to extend outwardly from the package; and
adhesive for the attachment of the roller and handle assemblies to the package.

2. The apparatus of claim 1, wherein the package further comprises a package outer surface.

3. The apparatus of claim 2, wherein the package outer surface includes a package bottom surface and package side surfaces separated from the package bottom surface by package lower edges, in which the roller assembly further comprises:
a roller mounting sheet having a roller mounting sheet contact side which is folded to define a roller mounting sheet bottom and a roller mounting sheet side such that the roller mounting sheet fits around a package lower edge, with the roller mounting sheet bottom resting against and adhesively bonding to the package bottom surface and the roller mounting sheet side resting against and adhesively bonding to a package side surface.

4. The apparatus of claim 3 which further comprises:
a spaced apart pair of axle mounting flanges extending outwardly from said roller mounting sheet and below the package bottom surface with the axle mounted roller disposed therebetween.

5. The apparatus of claim 4 which further comprises:
a roller axle extending between and connected to the axle mounting flanges; and
the axle mounted roller having a roller axial passageway, with a roller axle fitting through the roller axial passageway such that the roller is rotatably mounted around the roller axle.

6. The apparatus of claim 1, wherein the adhesive is a pressure sensitive adhesive which is exposed for use by removal of release papper.

7. The apparatus of claim 1, wherein the handle assembly comprises:
a handle mounting sheet having a handle mounting sheet that adhesively bonds to the package; and
a handle connected to said handle mounting sheet.

8. The apparatus of claim 7, wherein the handle is substantially U-shaped and has two spaced apart handle legs with leg first ends interconnected by a connecting segment and with leg second ends pivotally connected to the handle mounting sheet.

9. The apparatus of claim 8, wherein said handle is a cutout of the handle mounting sheet having no adhesive on its side that contacts the package, such that the handle remains substantially flush with the handle mounting sheet after adhesion of the handle mounting sheet to a package surface until pulled outwardly from the handle mounting sheet by a user.

10. The apparatus of claim 7, wherein the handle mounting sheet includes two spaced apart slide holes, and in which the handle comprises a wire bent into a general U-shape with spaced apart handle legs having leg first ends interconnected by a connecting segment and having leg second ends, the handle legs fitting slidably through corresponding the slide holes, the leg second ends having leg lateral bends;
such that a user slides the handle legs out of the slide holes until the leg lateral bends abut the handle mounting sheet side adjacent to the slide holes and transfer gripping and pulling loading on the handle to the handle mounting sheet and to the package.
